(19) United States
(12) Patent Application Publication
(10) Pub. No.: US 2012/0106348 A1
(43) Pub. Date: May 3, 2012

(54) Dynamic QOS Tagging for RTP Packets

(76) Inventors: Ramsundar Janakiraman, Sunnyvale, CA (US); Ravinder Verma, Bangalore (IN); Rajneesh Bajpai, San Jose, CA (US); Saji Xavier, Bangalore (IN)

(21) Appl. No.: 12/916,281

(22) Filed: Oct. 29, 2010

(51) Int. Cl. H04L 12/26

(52) U.S. Cl. 370/241

(57) ABSTRACT

Improved handling of RTP streams in digital networks. A switching device in a digital network such as a controller, bridge, or access point examines streams flowing through the device. The device monitors the initial UDP packets of a stream until a predetermined number of packets have been monitored. The device monitors and fingerprints the header portion of UDP packets, looking for RTP header bit patterns, ignoring certain RTP packet types, and caching others. This fingerprinting process attempts to match cached packet header information against subsequent packets in the stream to detect RTP streams. If the stream is determined to be an RTP stream, then the RTP type from the packet header is used to tag the stream. In one embodiment, such tags are QoS tags. Tagging may also be based on the control session port used.

### BACKGROUND OF THE INVENTION

The present invention relates to digital networks, and in particular, to delivering and managing reliable delivery of RTP streams.

Digital networks have rapidly become the backbone of many enterprises, small and large. Such networks are used for handling many different kinds of traffic. The RTP (Real-time Transport Protocol), as defined in RFC 1889 and RFC 3550 defines handling of streaming media commonly used for voice, video, telephony, and the like.

Many applications which use RTP to deliver streaming media such as voice or video perform end-to-end encryption on their signaling sessions, which render Application Level Gateways (ALGs) as part of firewalls useless. Encryption of RTP streams defeats attempts to recognize RTP streams based on simple pattern recognition and/or regular expression matching of RTP payload data, as encryption makes those RTP payloads unavailable for deep packet inspection. Additionally, identifying RTP packets just based on the protocol header fields can lead to false positives due to small static header patterns. An RTP recognition process needs to consider the recurring fields in the subsequent RTP packets to ensure determinism in RTP identification process.

What is needed is a way to improve handling of RTP streams passing through networks.

### BRIEF DESCRIPTION OF THE DRAWINGS

The invention may be best understood by referring to the following description and accompanying drawings that are used to illustrate embodiments of the invention in which:

FIG. 1 shows clients in a network.

### DETAILED DESCRIPTION

Embodiments of the invention relate to methods of improving the handling of RTP streams in digital networks.

According to the present invention, a switching device in a digital network such as a controller, bridge, or access point examines streams flowing through the device. When the device detects that a session has been initiated, the device monitors the initial UDP packets of that stream until a predetermined number of packets have been monitored. The device monitors and fingerprints the header portion of UDP packets, looking for RTP header bit patterns, ignoring certain RTP packet types, and caching others. This fingerprinting process continues, attempting to match cached packet header information against subsequent packets in the stream to detect RTP streams deterministically. If the stream is determined to be an RTP stream, then the RTP type from the packet header is used to tag the stream. In one embodiment, such tags are QoS tags. Tagging may also be based on the control session port used.

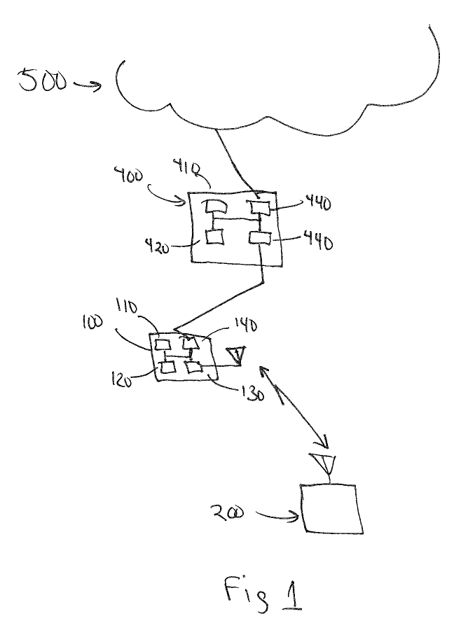

FIG. 1 shows a network in which access points (APs) 100 are purpose-made digital devices, each containing a processor 110, memory hierarchy 120, and input-output interfaces 130. In one embodiment of the invention, a MIPS-class processor such as those from Cavium or RMI is used. Other suitable processors, such as those from Intel or AMD may also be used. The memory hierarchy 120 traditionally comprises fast read/write memory for holding processor data and instructions while operating, and nonvolatile memory such as EEPROM and/or Flash for storing files and system startup information. Wired interfaces 140 are typically IEEE 802.3 Ethernet interfaces, used for wired connections to other network devices such as switches, or to a controller. Wireless interfaces 130 may be WiMAX, 3G, 4G, and/or IEEE 802.11 wireless interfaces. In one embodiment of the invention, APs operate under control of a LINUX operating system, with purpose-built programs providing host controller and access point functionality. Access points 100 typically communicate with a controller 400, which is also a purpose-built digital device having a processor 410, memory hierarchy 420, and commonly a plurality of wired interfaces 440. Access points 100 may also include devices operating as bridges, remote access points, and the like. Controller 400 provides access to network 500, which may be a private intranet or the public internet.

Client devices 200 have similar architectures, chiefly differing in input/output devices; a laptop computer will usually contain a large LCD, while a handheld wireless scanner will typically have a much smaller display, but contain a laser barcode scanner.

The present invention deals with RTP (Real-time Transport Protocol) data streams, as defined in RFC 1889 and RFC 3550 and incorporated herein by reference. RTP streams are typically used for the end-to-end transport of streaming media in real time, such as voice and/or video. RTP is based on UDP, a connectionless protocol. UDP is a simple transmission protocol, defined in RFC 768, without implicit hand-shaking dialogs for providing reliability, packet ordering, or data integrity. It is understood that UDP provides a service without reliability guarantees, and that UDP datagrams may arrive out of order, appear duplicated, or go missing without notice, assuming that error detection and correction if any is either not necessary or is performed in the client application.

It is common for applications using RTP streams to encrypt the payload portion of the RTP packet, leaving only the RTP header available for inspection. This encryption, such as applied by applications such as Microsoft OCS or SIP-over-IPSEC, cause methods of identifying RTP streams by deep packet inspection of RTP payloads to fail. Additionally, attempting to identify RTP packets just based on the protocol header fields can lead to false positives due to small static header patterns. An RTP identification process needs to consider the recurring fields in the subsequent RTP packets to ensure determinism in RTP identification process.

According to the present invention, a network device such as a controller, bridge, or access point monitors the traffic it is carrying to detect and tag RTP streams. Packets are fingerprinted and cached, the cached information being used to determine if the stream is an RTP stream.

The device monitors UDP packets for the session until a predetermined packet count has been reached. Additional optimization can be applied, by triggering the detection based on the initiation of active control sessions, for example, control sessions which are pre-configured on ports that the server listens on for SIP clients such as TCP:2000 or TCP:5060. In one embodiment, initial packets such as STUN, TURN, and ICE which are used to establish NAT traversal are ignored.

As part of the fingerprinting process, packets which match RTP header bit patterns are cached. This cached information includes selective RTP header information on the RTP flow state such as SSRC, CSRC, and RTP type. The entire packet may be cached, or just the header portion of the packet header containing the fingerprinted information may be cached.

These cached packets for the stream are used to try and match subsequent packets in the stream to determine if the stream is an RTP stream or not.

If a predetermined number of matches occur, the stream is identified as an RTP stream.

Once the stream has been identified as an RTP stream, the RTP type field from the RTP header may be used to tag packets belonging to the stream. As an example, QoS (Quality of Service) tags may be added to speed reliable delivery of RTP streams identified as video or voice streams. The type of tag applied may also depend on the control session port.

The present invention may be realized in hardware, software, or a combination of hardware and software. The present invention may be realized in a centralized fashion in one computer system such as AP 100, or in a distributed fashion where different elements are spread across several interconnected computer systems. A typical combination of hardware and software may be a controller or access point with a computer program that, when being loaded and executed, controls the device such that it carries out the methods described herein.

The present invention also may be embedded in nontransitory fashion in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

I claim:

1. A method of identifying an RTP stream in a device attached to a digital network comprising:
fingerprinting a preset number of RTP packets in a stream received by the device,
caching the fingerprinted RTP packets,
matching the cached fingerprinted RTP packets to incoming RTP packets, and
identifying the stream as an RTP stream if a predetermined number of matches occur.

2. The method of claim 1 where fingerprinting of RTP packets is initiated by the detection of an RTP session.

3. The method of claim 1 where fingerprinting of RTP packets excludes certain RTP packets.

4. The method of claim 3 where the excluded RTP packets include STUN, TURN, and ICE packets.

5. The method of claim 1 further comprising tagging the identified RTP stream.

6. The method of claim 5 where the identified RTP stream is tagged based on the RTP type.

7. The method of claim 5 where the identified RTP stream is tagged based on the control port.

8. The method of claim 5 where the identified RTP stream is tagged with QoS tags.

9. A machine readable medium having a set of instructions stored in nonvolatile form therein, which when executed on a device attached to a digital network causes a set of operations to be performed comprising:
fingerprinting a preset number of RTP packets in a stream received by the device,
caching the fingerprinted RTP packets,
matching the cached fingerprinted RTP packets to incoming RTP packets,
identifying the stream as an RTP stream if a predetermined number of matches occur, and
tagging the matched RTP stream.

10. The machine readable medium of claim 9 where the step of fingerprinting a preset number of RTP packets excludes certain RTP packets including STUN, TURN, and ICE packets.

11. The machine readable medium of claim 9 where the RTP stream is tagged based on the RTP type.

12. The machine readable medium of claim 9 where the RTP stream is tagged based on the control port.
